(19) United States
(12) Patent Application Publication
(10) Pub. No.: US 2014/0129761 A1
(43) Pub. Date: May 8, 2014

(54) NON-VOLATILE MEMORY DEVICE AND HOST DEVICE CONFIGURED TO COMMUNICATION WITH THE SAME

(71) Applicant: SAMSUNG ELECTRONICS CO., LTD., Suwon-Si (KR)

(72) Inventor: MOON-SANG KWON, Seoul (KR)

(73) Assignee: SAMSUNG ELECTRONICS CO., LTD., Suwon-Si (KR)

(21) Appl. No.: 14/069,719

(22) Filed: Nov. 1, 2013

(30) Foreign Application Priority Data
Nov. 2, 2012 (KR) 10-2012-0123744

(51) Int. Cl. G06F 12/02

(52) U.S. Cl. CPC G06F 12/0246
USPC 711/103

(57) ABSTRACT

A non-volatile memory device and a non-volatile memory host device are configured to communicate with the non-volatile memory device. The speed at which the non-volatile memory device responds to a request for accessing user data from the host device may be increased. The non-volatile memory device may transmit logical-physical address mapping information regarding user data to the host device and may receive a request and logical-physical address mapping information from the host device. The host device may receive and store the logical-physical address mapping information from the non-volatile memory device and may transmit the request for accessing the user data and stored mapping information to the non-volatile memory device.

### CROSS-REFERENCE TO RELATED APPLICATIONS

This application claims the benefit of Korean Patent Application No. 10-2012-123744, filed on Nov. 2, 2012, in the Korean Intellectual Property Office, the disclosure of which is incorporated by reference herein in its entirety.

### TECHNICAL FIELD

The inventive concept relates to a non-volatile memory device, and more particularly, to a non-volatile memory device and a host device configured to communicate with the non-volatile memory device.

### DISCUSSION OF THE RELATED ART

A data storage device which retains data stored therein even when power supply is interrupted is referred to as a non-volatile memory. For example, non-volatile memories may include a read-only memory (ROM), a magnetic disk, an optical disk, and a flash memory. In particular, flash memories may be configured to store data by varying threshold voltages of a MOS transistor. Examples of flash memories include a NAND flash memory and a NOR flash memory.

Non-volatile memory devices may include either a non-volatile memory alone or a non-volatile memory in combination with a memory controller. A host or a host device may communicate with the non-volatile memory device and may request the non-volatile memory device to write or read data. Due to structural characteristics of the non-volatile memory, the memory controller may perform an operation, which is not recognized by the host device. As a result, a speed at which the non-volatile memory device responds to a request from the host device may be reduced.

### SUMMARY

The inventive concept provides a non-volatile memory device and a host device configured to communicate with the non-volatile memory device. The speed at which the non-volatile memory device responds to a request from the host device may be increased.

According to an aspect of the inventive concept, there is provided a non-volatile memory device including a non-volatile cell array configured to store data and mapping information having a logical address of the data and a physical address of the data. A controller of the non-volatile memory device is configured to transmit, to an external host device, at least one portion of the mapping information stored in the non-volatile cell array. The controller receives, from the external host device, mapping information of data requested to be accessed and accesses the data requested to be accessed based on address information extracted from the mapping information received from the external host.

The controller may further include a storage unit to which the at least one portion of the mapping information stored in the non-volatile cell array is copied. The controller may access the data requested to be accessed based on the mapping information stored in the non-volatile cell array or the mapping information received from the external host device.

The controller may determine whether the mapping information received from the external host device is valid. When it is determined that the mapping information received from the external host device is invalid, the controller may access the data requested to be accessed based on the mapping information stored in the non-volatile cell array or the mapping information stored in the storage unit.

When mapping information regarding the physical address corresponding to the logical address of the data is changed, the controller may store the changed mapping information in the non-volatile cell array or the storage unit and transmit the changed mapping information to the host device.

The controller may scramble the at least one portion of the mapping information, transmit the scrambled mapping information to the external host device, unscramble the scrambled mapping information received from the external host device, and access the data based on the unscrambled mapping information.

The controller may include a verification unit configured to determine whether the mapping information received from the external host device is valid. A data access unit of the controller is configured to access the data stored in the non-volatile cell array by using the mapping information received from the external host device. A mapping information transmitting unit of the controller is configured to transmit, to the external host device, the at least one portion of the mapping information stored in the non-volatile cell array.

According to an aspect of the inventive concept, there is provided a non-volatile memory host device including a storage unit configured to store mapping information having a logical address of data stored in a non-volatile memory device and a physical address of the data. A controller is configured to communicate with the non-volatile memory device and transmit a request for accessing the data and the mapping information stored in the storage unit. The transmitted request pertains to the data requested to be accessed to the non-volatile memory device.

The controller may receive, from the non-volatile memory device, the accessed mapping information stored in the non-volatile memory host device and may store the received mapping information in the storage unit.

When the request is a write request, the controller may invalidate the mapping information, stored in the storage unit, of data corresponding to the write request, and update the invalidated mapping information with new mapping information.

### BRIEF DESCRIPTION OF THE DRAWINGS

Exemplary embodiments of the inventive concept will be more clearly understood from the following detailed description taken in conjunction with the accompanying drawings in which:

FIG. 1 is a diagram of a non-volatile memory device and a host device configured to communicate with the non-volatile memory device, according to exemplary embodiments of the inventive concept;

FIG. 2 is a diagram of an example of a memory controller of FIG. 1, according to exemplary embodiments of the inventive concept;

FIG. 3 is a diagram of an example of the host device and a non-volatile cell array of FIG. 1, according to exemplary embodiments of the inventive concept;

FIG. 4A through 4C are diagrams of signals received by a non-volatile memory device from a host device, according to exemplary embodiments of the inventive concept;

FIG. 5 is a diagram of an example of the host device of FIG. 1, according to exemplary embodiments of the inventive concept;

FIG. 6 is a flowchart illustrating an operation of the non-volatile memory device of FIG. 1, according to exemplary embodiments of the inventive concept;

FIG. 7 is a flowchart illustrating an operation of the host device of FIG. 1, according to exemplary embodiments of the inventive concept;

FIGS. 8A and 8B are diagrams of an example of a memory controller of a non-volatile memory device, according to exemplary embodiments of the inventive concept;

FIGS. 9A and 9B are diagrams of an example of a memory controller of the non-volatile memory device, according to exemplary embodiments of the inventive concept;

FIG. 10 is a flowchart illustrating an operation of the memory controller of FIG. 9A, according to exemplary embodiments of the inventive concept;

FIG. 11 is a construction diagram of a memory card and a host device, according to exemplary embodiments of the inventive concept; and

FIG. 12 is a block diagram of a computing system including a non-volatile storage and a host device, according to exemplary embodiments of the inventive concept.

### DETAILED DESCRIPTION

Exemplary embodiments of the present inventive concept will now be described more fully hereinafter with reference to the accompanying drawings. This inventive concept may, however, be embodied in different forms and should not be construed as limited to the embodiments set forth herein. Rather, these embodiments are provided so that this disclosure is thorough and complete and fully conveys the scope of the inventive concept to one skilled in the art.

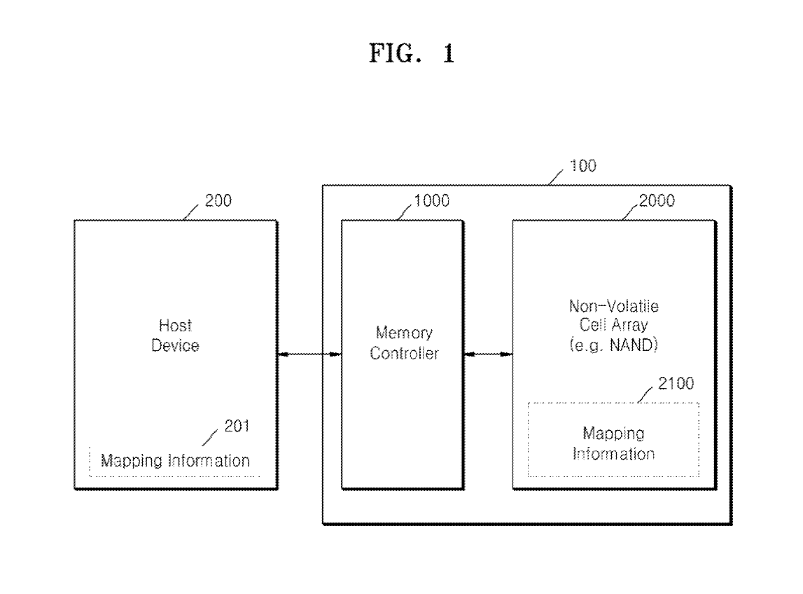

FIG. 1 is a diagram of a non-volatile memory device 100 and a host device 200 configured to communicate with the non-volatile memory device, according to exemplary embodiments of the inventive concept. The non-volatile memory device 100 may include a non-volatile cell array 2000 and a memory controller 1000 configured to control the non-volatile cell array 2000. The host device 200 may communicate with the non-volatile memory device 100 and write and/or read data from the non-volatile memory device 100. In particular, the data written or read by the host device 200 may be referred to as user data.

As mentioned above, the non-volatile cell array 2000 may store data or retain stored data even in the absence of supplied power. The non-volatile cell array 2000 may further store logical-physical address mapping information 2100 for the non-volatile memory device 100 along with the user data.

A logical address may be an address of user data recognized by the host device 200. The host device 200 may reference a logical address instead of a physical address in writing or reading the user data. The physical address is an address of a space in which the user data is actually stored in the non-volatile cell array 2000. The memory controller 1000 may receive a request for accessing the user data and the logical address from the host device 200 and may either write the user data in a space indicated by the physical address corresponding to the logical address or read the user data stored in the space.

The non-volatile cell array 2000 may retain stored data even when power supply is interrupted. A NAND flash memory, which is an example of the non-volatile cell array 2000, may perform data program and read operations in units of pages but perform a data erase operation in units of blocks, which are larger than the units of pages. Accordingly, when the host device 200 intends to change user data stored in the NAND flash memory in a specific address, the host device 200 may erase a block in which the user data is stored, and then program the user data to be changed. In the NAND flash memory, since it takes a longer time to perform the erase operation than other operations, the memory controller 1000 included in the non-volatile memory device 100 might not erase a block in which user data is stored, but may instead write the user data to be changed in a vacant space of the non-volatile cell array 2000. Thus, the memory controller 1000 may further store an address of the space in which new user data (e.g., changed user data) is stored, so information regarding translation between logical and physical addresses may be changed. The host device 200 may transmit a logical address of the user data to the non-volatile memory device 100, and the memory controller 1000 of the non-volatile memory device 100 may access the user data using a physical address (e.g., translated physical address) corresponding to the logical address.

In addition, the logical-physical address mapping information 2100 may be changed due to other causes. For instance, the number of times non-volatile cells included in the non-volatile cell array 2000 may be programmed or erased may be finite. Accordingly, to increase the lifespan of the non-volatile memory device 100, the memory controller 1000 may prevent a specific portion of the non-volatile cell array 2000 from being repetitively programmed or erased. For example, a physical address corresponding to a logical address may be changed to program or erase all the cells as uniformly as possible. This operation of the memory controller 1000 may be referred to as a wear-leveling operation. In addition, the logical-physical address mapping information 2100 may be changed due to a garbage collection operation of the memory controller 1000, which may function to erase unused memory cells so that they may be reused.

As mentioned above, a logical address recognized by the host device 200 with respect to the non-volatile memory device 100 and a physical address used by the memory controller 1000 included in the non-volatile memory device 100 to manage the non-volatile cell array 2000 may make a pair. Information regarding the physical address corresponding to a given logical address is referred to as logical-physical address mapping information (hereinafter, referred to as mapping information) 2100, and the memory controller 1000 may extract a physical address corresponding to a logical address received from the host device 200 based on the mapping information 2100. The mapping information 2100 should be retained even if power supplied to the host device 200 or the non-volatile memory device 100 is interrupted. Thus, as shown in FIG. 1, the mapping information 2100 may be stored in the non-volatile cell array 2000 along with the user data. Also, the memory controller 1000 may include a volatile or non-volatile storage unit, and at least a portion of the mapping information 2100 stored in the non-volatile cell array 2000 may be stored in the storage unit of the memory controller 1000 during operations of the non-volatile memory device 100.

In an embodiment of the inventive concept, the host device 200 may store at least a portion 201 of the mapping information 2100 stored in the non-volatile cell array 2000. To this end, the memory controller 1000 may transmit at least a portion of the mapping information 2100 stored in the non-volatile cell array 2000, and the host device 200 may store the mapping information 201 received from the non-volatile memory device 100. The host device 200 may communicate with the non-volatile memory device 100 using the mapping information 201 stored therein, as described in greater detail below.

The non-volatile cell array 2000 may include cells configured to retain stored data even when power supply is interrupted. For example, the non-volatile cell array 2000 may include NAND or NOR flash memory cells, magnetic random access memory (MRAM) cells, resistive RAM (RRAM) cells, ferroelectric RAM (FRAM) cells, or phase-change memory (PCM) cells.

A non-volatile memory device may be defined as a device including peripheral circuits (e.g., a row decoder and a column decoder) configured to write or read data to or from non-volatile cells. A non-volatile memory system may be defined as a system including a non-volatile memory device and a memory controller.

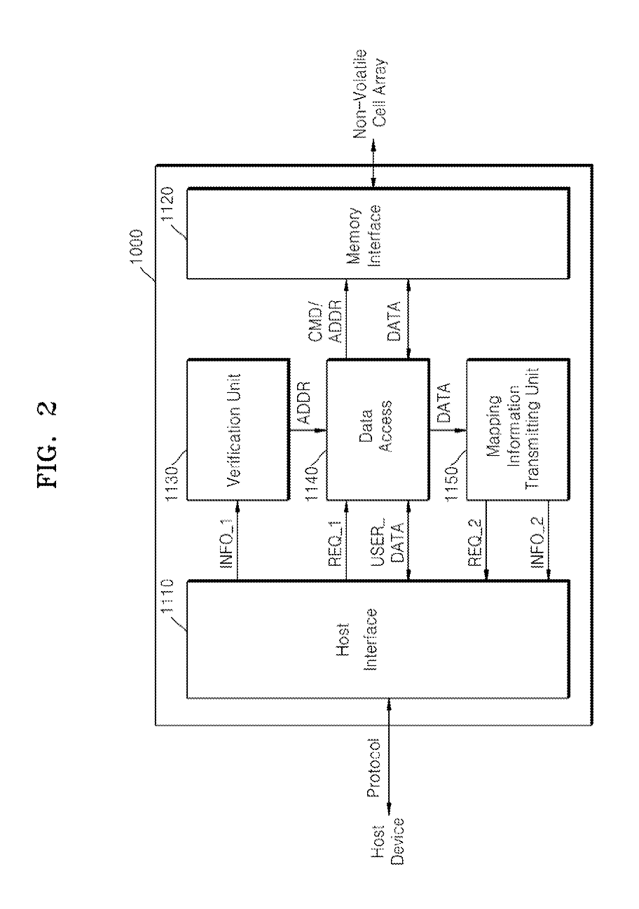

FIG. 2 is a diagram of an example of the memory controller 1000 of FIG. 1, according to exemplary embodiments of the inventive concept. The non-volatile memory device 100 of FIG. 1 may include the memory controller 1000, which may receive various requests from the host device 200 and perform required operations on the non-volatile cell array 2000 in response to the requests. As shown in FIG. 2, the memory controller 1000 may include a host interface 1110, a memory interface 1120, a verification unit 1130, a data access unit 1140, and a mapping information transmitting unit 1150.

The host interface 1110 may receive a first request REQ_{—}1 from the host device 200 of FIG. 1, and transmit and receive data user data USER_DATA and a logical address of the user data USER_DATA. For example, when the first request REQ_{—}1 is a request to write the user data USER_DATA, the host interface 1110 may receive the user data USER_DATA and first mapping information INFO_{—}1 regarding the user data USER_DATA from the host device 200. In an embodiment of the inventive concept, the host interface 1110 may receive the first mapping information INFO_{—}1 and transmit the received first mapping information INFO_{—}1 to the verification unit 1130. The first mapping information INFO_{—}1 may include mapping information between the logical address and a physical address of the user data USER_DATA requested to be written or read. The host interface 1110 may not only receive the first mapping information INFO_{—}1 from the host device 200 but may also receive second mapping information INFO_{—}2 from the mapping information transmitting unit 1150 and transmit the second mapping information INFO_{—}2 to the host device 200. Also, the host interface 1110 may receive a second request REQ_{—}2 from the mapping information transmitting unit 1150 and transmit the second request REQ_{—}2 to the host device 200. A description of the second request REQ_{—}2 is provided in detail below. The host interface 1110 may communicate with the host device 200 through a predetermined protocol. For instance, the protocol may be an embedded multimedia card (eMMC) or secure digital (SD) protocol, a serial advanced technology attachment (SATA), a serial attached small computer systems interface (SCSI), a serial attached SCSI (SAS), a non-volatile memory express (NVMe), or a universal serial bus (USB).

The memory interface 1120 may output commands and physical addresses to the non-volatile cell array 2000 of FIG. 1 and transmit and receive data to and from the non-volatile cell array 2000 of FIG. 1. The memory interface 1120 may receive commands CMD and physical addresses ADDR from the data access unit 1140 and transmit and receive data DATA to and from the data access unit 1140.

The verification unit 1130 may receive the first mapping information INFO_{—}1 from the host interface 1110 and determine whether the first mapping information INFO_{—}1 is valid. For example, when the physical address extracted from the first mapping information INFO_{—}1 received from the host device 200 indicates a region of the non-volatile cell array 2000 that cannot be accessed by the host device 200, the verification unit 1130 may ignore the first mapping information INFO_{—}1 received from the host device 200. Also, when mapping information is changed due to a wear-leveling or garbage collection operation performed by the memory controller 1000 of the non-volatile memory device 100, the verification unit 1130 may ignore the first mapping information INFO_{—}1 received from the host device 200. When the first mapping information INFO_{—}1 received from the host device 200 is ignored by the verification unit 1130, the memory controller 1000 may extract a physical address from the mapping information 2100 stored in the non-volatile cell array 2000 of FIG. 1. Alternatively, when at least portion of the mapping information 2100 is loaded in the storage unit of the memory controller 1000, the memory controller 1000 may extract the physical address using at least the portion of the mapping information 2100 loaded in the storage unit of the memory controller 1000.

The data access unit 1140 may transmit commands CMD and physical addresses ADDR to the memory interface 1120 and transmit and receive data to and from the memory interface 1120. For example, the data access unit 1140 may generate commands CMD to access the non-volatile cell array 2000 in response to write/read requests received from the host device 200. The non-volatile cell array 2000 of FIG. 1 may store data DATA, which may be user data USER_DATA or mapping information 2100. For example, the data access unit 1140 may receive the first request REQ_{—}1 from the host interface 1110 and transmit a command CMD to the memory interface 1120, and transmit and receive user data USER_DATA, which is transmitted to and received from the host interface 1110, to and from the memory interface 1120. A physical address ADDR transmitted by the data access unit 1140 to the memory interface 1120 may be a physical address received from the verification unit 1130, a physical address obtained based on mapping information 2100 received from the non-volatile cell array 2000 through the memory interface 1120, or mapping information loaded in the storage unit of the memory controller 1000. For example, when the first mapping information INFO_{—}1 is ignored by the verification unit 1130, the physical address ADDR obtained based on the mapping information 2100 received through the memory interface 1120 may be transmitted to the memory interface 1120.

The mapping information transmitting unit 1150 may receive data including the second mapping information INFO_{—}2 from the data access unit 1140 and transmit the second mapping information INFO_{—}2 through the host interface 1110 to the host device 200. As shown in FIG. 1, the host device 200 may store at least a portion 201 of the mapping information 2100 stored in the non-volatile cell array 2000. To this end, the host device 200 may receive the at least one portion of the mapping information 2100 from the non-volatile memory device 100. For example, the host interface 1110 may receive the first request REQ_{—}1 for transmitting mapping information 2100 from the host device 200 and transmit the first request REQ_{—}1 to the data access unit 1140. The data access unit 1140 may control the non-volatile cell array 2000 via the memory interface 1120 in response to the first request REQ_{—}1, receive the mapping information 2100 stored in the non-volatile cell array 2000, and transmit the mapping information 2100 to the mapping information transmitting unit 1150. The mapping information transmitting unit 1150 may extract second mapping information INFO_{—}2 from the mapping information 2100 received from the data access unit 1140 and transmit the second mapping information INFO_{—}2 via the host interface 1110 to the host device 200.

The mapping information transmitting unit 1150 may transmit the second request REQ_{—}2 via the host interface 1110 to the host device 200. For example, the mapping information transmitting unit 1150 may transmit the second request REQ_{—}2 for requesting transmission of mapping information stored in the host device 200 via the host interface 1110 to the host device 200. Also, when the mapping information 2100 stored in the non-volatile cell array 2000 is changed, the mapping information transmitting unit 1150 may transmit the second request REQ_{—}2 for requesting the host device 200 to update the portion 201 of the mapping information stored in the host device 200, via the host interface 1110. The host device 200 may transmit the first mapping information INFO_{—}1 to the non-volatile memory device 100 via the host interface 1110 in response to the second request REQ_{—}2 or receive the second mapping information INFO_{—}2 from the non-volatile memory device 100.

In an embodiment of the inventive concept, the mapping information transmitting unit 1150 may scramble or otherwise encrypt the mapping information received from the data access unit 1140. For example, the first and second mapping information INFO_{—}1 or INFO_{—}2 transmitted and received between the non-volatile memory device 100 and the host device 200 may be scrambled so that the mapping information of the non-volatile memory device 100 can be kept secure. When the first and second mapping information INFO_{—}1 and INFO_{—}2 are scrambled, the verification unit 1130 may further perform an operation of unscrambling the first mapping information INFO_{—}1 received from the host device 200 via the host interface 1110.

The scrambling of mapping information may be enabled using an arbitrary method for precluding other host devices from recognizing the mapping information. For example, the scrambling process may include an encryption process.

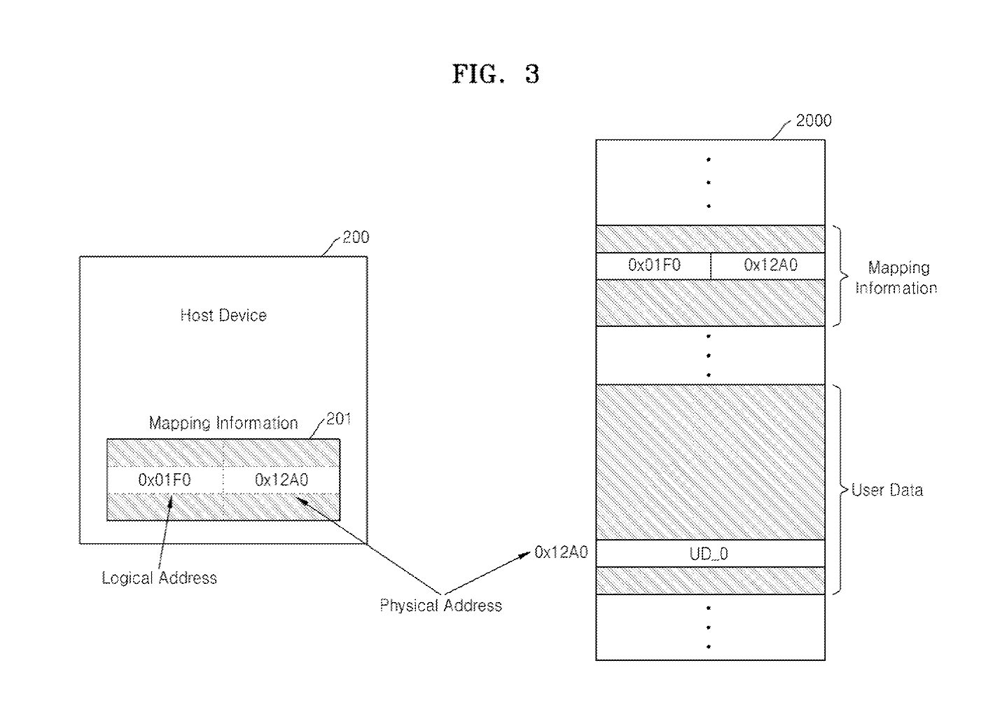

FIG. 3 is a diagram of an example of the host device 200 and non-volatile cell array 2000 of FIG. 1, according to exemplary embodiments of the inventive concept. The host device 200 may store at least one portion 201 of the mapping information 2100 as described above, and FIG. 3 shows an example in which the host device 200 stores mapping information regarding a logical address “0x01F0”. When the host device 200 transmits the mapping information regarding the logical address “0x01F0” along with a request for reading user data to the non-volatile memory device, the memory controller (refer to 1000 in FIG. 1) may access user data UD_{—}0 stored in the non-volatile cell array 2000 based on a physical address “0x12A0” included in the mapping information received from the host device 200, rather than based on a physical address “0x12A0” included in the mapping information stored in non-volatile cell array 2000. Thus, the non-volatile memory device may rapidly respond to the request for reading the user data, which is received from the host device 200 so that time taken to read the user data UD_{—}0 can be shortened.

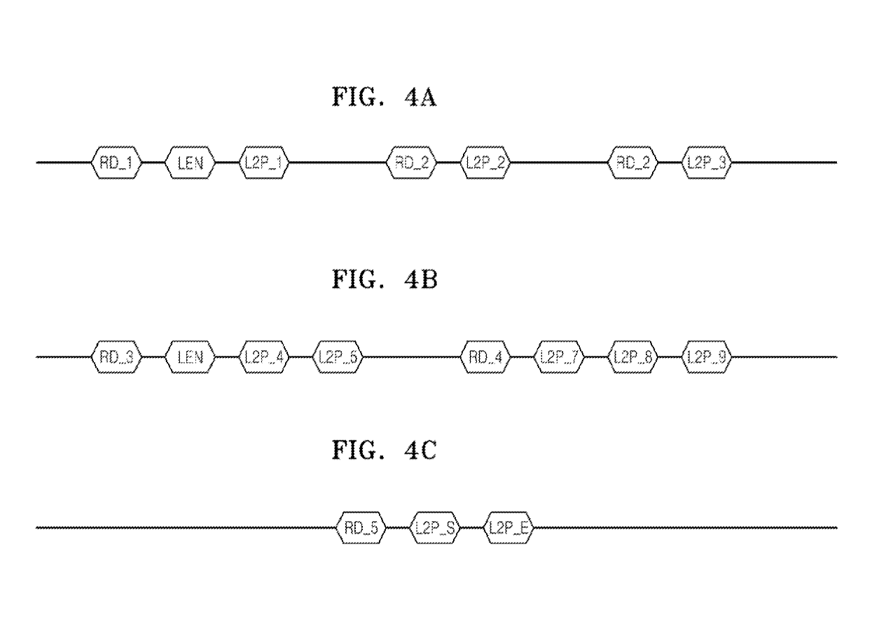

FIG. 4A through 4C are diagrams illustrating a signal received from a host device by a non-volatile memory device, according to exemplary embodiments of the inventive concept. The non-volatile memory device 100 of FIG. 1 may receive mapping information along with a request from the host device 200. For example, as shown in FIG. 4A through 4C, the host device 200 may transmit a read request to read user data stored in the non-volatile memory device 100. As shown in FIG. 4A, the host device 200 may transmit a first read request RD_{—}1, a user data length LEN, and mapping information L2P_{—}1 to the non-volatile memory device 100. In response to the first read request RD_{—}1, the user data length LEN, and the mapping information L2P_{—}1, the non-volatile memory device 100 may transmit, to the host device 200 by as much as the user data length LEN, user data stored in a space corresponding to the mapping information L2P_{—}1. The user data length LEN may be omitted. In this case, the user data length LEN may be a predetermined length or may be determined by prearranged conditions. For example, the host device 200 may transmit only a second read request RD_{—}2 and mapping information L2P_{—}2 or L2P_{—}3 to the non-volatile memory device 100. Thus, in response to the second read request RD_{—}2 and the mapping information L2P_{—}2 or L2P_{—}3, the non-volatile memory device 100 may transmit, to the host device 200 and by a predetermined length, user data stored in a space corresponding to the mapping information LSP_{—}2 or L2P_{—}3.

FIG. 4B shows a case in which the non-volatile memory device 100 receives one request and a plurality of pieces of mapping information. As shown in FIG. 4B, the host device 200 may transmit a third read request RD_{—}3, a user data length LEN, and a plurality of pieces of mapping information L2P_{—}4 and L2P_{—}5. In response to the third read request RD_{—}3, the user data length LEN, and the plurality of pieces of mapping information L2P_{—}4 and L2P_{—}5, the non-volatile memory device 100 may sequentially transmit user data stored in spaces corresponding respectively to the plurality of pieces of mapping information L2P_{—}4 and L2P_{—}5 to the host device 200 by as much as the user data length LEN. Also, the host device 200 may omit the user data length LEN and transmit a fourth read request RD_{—}4 and a plurality of pieces of mapping information L2P_{—}7, L2P_{—}8, and L2P_{—}9 to the non-volatile memory device 100. The non-volatile memory device 100 may sequentially transmit, to the host device 200 and by as much as a predetermined length, user data stored in spaces corresponding respectively to the plurality of pieces of mapping information L2P_{—}7, L2P_{—}8, and L2P_{—}9.

FIG. 4C shows a case in which the non-volatile memory device 100 receives one request and a pair of pieces of mapping information L2P_S and L2P_E. As shown in FIG. 4C, when required user data is stored in a space in which physical addresses are sequentially increased, the host device 200 may transmit a fifth read request RD_{—}5, start mapping information LSP_S, and end mapping information L2P_E. In response to the fifth read request RD_{—}5, the start mapping information L2P_S, and the end mapping information L2P_E, the non-volatile memory device 100 may sequentially transmit user data stored in a space corresponding to the start mapping information L2P_S through user data stored in a space corresponding to the end mapping information L2P_E to the host device 200.

Although FIG. 4A through 4C show an example in which a request transmitted by the host device 200 to the non-volatile memory device 100 is a read request, the present embodiments may be applied to other requests (e.g., write requests) that involve providing access to user data.

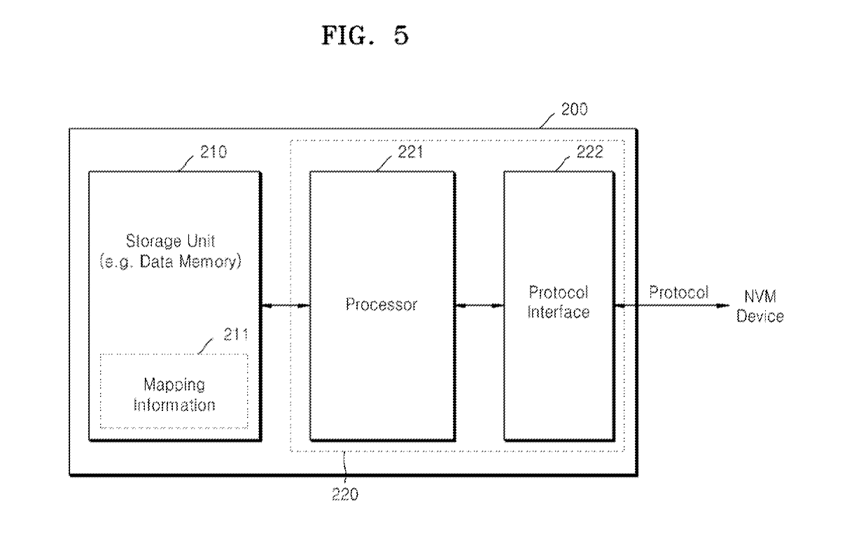

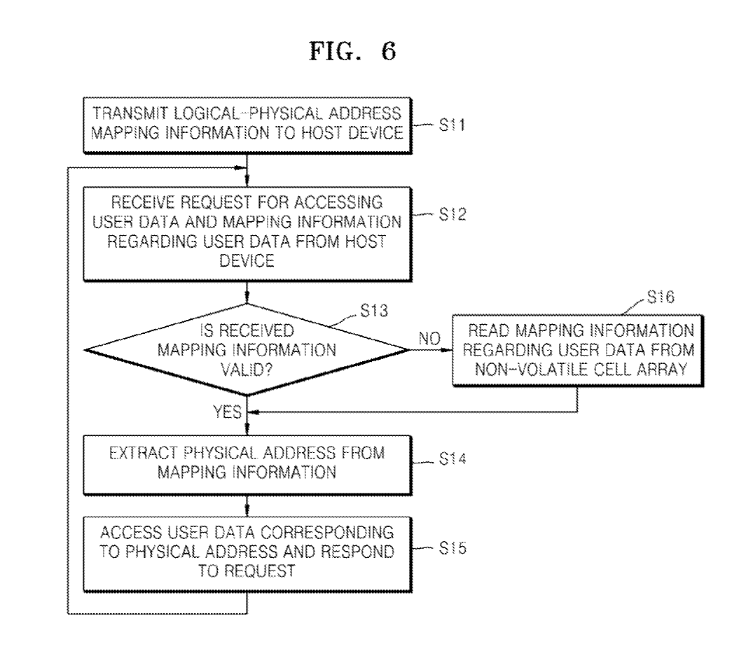

FIG. 5 is a diagram of an example of the host device 200 of FIG. 1, according to exemplary embodiments of the inventive concept. The host device 200 may communicate with the non-volatile memory device via a predetermined protocol to either read user data stored in the non-volatile memory device or write new user data in the non-volatile memory device. In an embodiment, the host device 200 may include a storage unit 210 and a host controller 220, and the host controller 220 may include a processor 221 and a protocol interface 222. As described above with reference to FIG. 1, the host device 200 may store at least a portion of mapping information stored in the non-volatile cell array (refer to 2000 in FIG. 1). With respect to the configuration shown in FIG. 5, the storage unit 210 may store mapping information 211. The storage unit 210 may be a memory configured to store the mapping information 211, for example, a data memory of the processor 221. The processor 221 may not only control the host device 200 but may also communicate with the non-volatile memory device 100 through the protocol interface 222 and write or read the user data. The protocol interface 222 may transmit or receive various requests, mapping information, and user data regarding the non-volatile memory from the processor 221, and communicate with the non-volatile memory device through a predetermined protocol.

The processor 221 may receive mapping information stored in the non-volatile cell array 2000 from the non-volatile memory device 100 and store the mapping information in the storage unit 210. The processor 221 may transmit the mapping information 211 stored in the storage unit 210, along with various requests, through the protocol interface 222 to the non-volatile memory device.

The processor 221 may invalidate a portion of the mapping information 211 stored in the storage unit 210. For example, when the processor 221 transmits the user data along with a write request for writing the user data, the memory controller (refer to 1000 in FIG. 1) included in the non-volatile memory device of FIG. 1 may perform an operation of writing user data received from the host device 200 in a vacant storage space instead of changing currently stored data due to the characteristics of the non-volatile cell array 2000. Accordingly, when a space in which the user data is stored is changed, the memory controller 1000 of the non-volatile memory device may change mapping information regarding the user data. For example, the memory controller 1000 may map a new physical address to a logical address of the user data. The new physical address may be internally determined by the memory controller of the non-volatile memory device. The host device 200 disposed outside the non-volatile memory device may require changed mapping information regarding the new physical address. Accordingly, the mapping information regarding the user data stored in the storage unit 210 may be invalid until the host device 200 receives the changed mapping information from the non-volatile memory device and stores the changed mapping information. The processor 221 may invalidate the mapping information and store an indication of whether the mapping information is valid or not in an additional space.

FIG. 6 is a flowchart illustrating an operation of the non-volatile memory device of FIG. 1, according to exemplary embodiments of the inventive concept. The memory controller included in the non-volatile memory device may transmit mapping information stored in a non-volatile cell array to a host device (operation S11). The host device may store the mapping information received from the non-volatile memory device. The non-volatile memory device may receive a request for providing access to user data and mapping information regarding the user data from the host device (operation S12).

The non-volatile memory device may simultaneously receive the request and the mapping information from the host device or request the mapping information to the host device and receive the mapping information.

A verification unit of the non-volatile memory device may determine whether the mapping information received from the host device is valid or not (operation S13). For example, when a physical address obtained based on the mapping information received from the host device indicates a space to which the host device cannot provide access, or when a physical address of user data is changed and the mapping information received from the host device is no longer valid, the verification unit may determine that the received mapping information is invalid. When the received mapping information is valid (Yes, S13), the memory controller of the non-volatile memory device may extract a physical address from the mapping information (operation S14), and provide access to user data corresponding to the physical address and respond to a request of the host device (operation S15). When the mapping information received from the host device is invalid (No, S13), the memory controller of the non-volatile memory device may read the mapping information stored in the non-volatile cell array (operation S16), extract a physical address from the mapping information (operation S14), and provide access to user data corresponding to the physical address and respond to a request of the host device (operation S15).

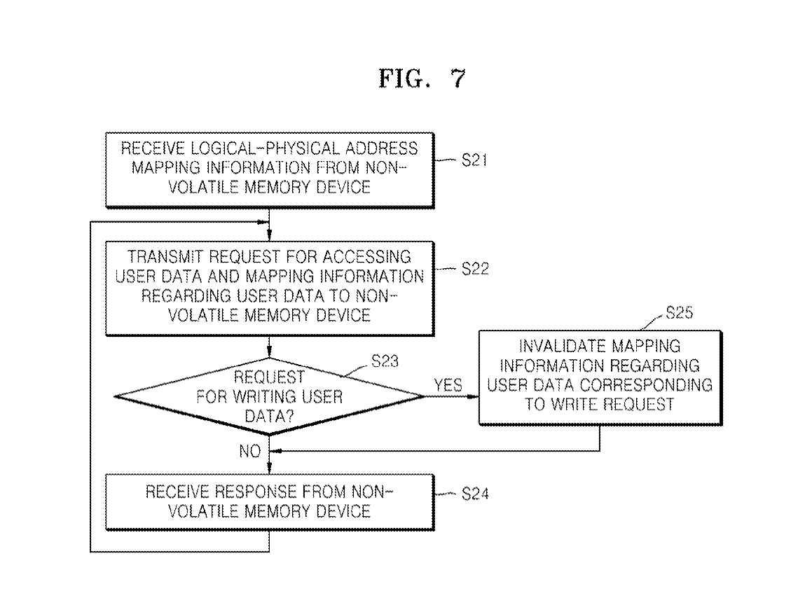

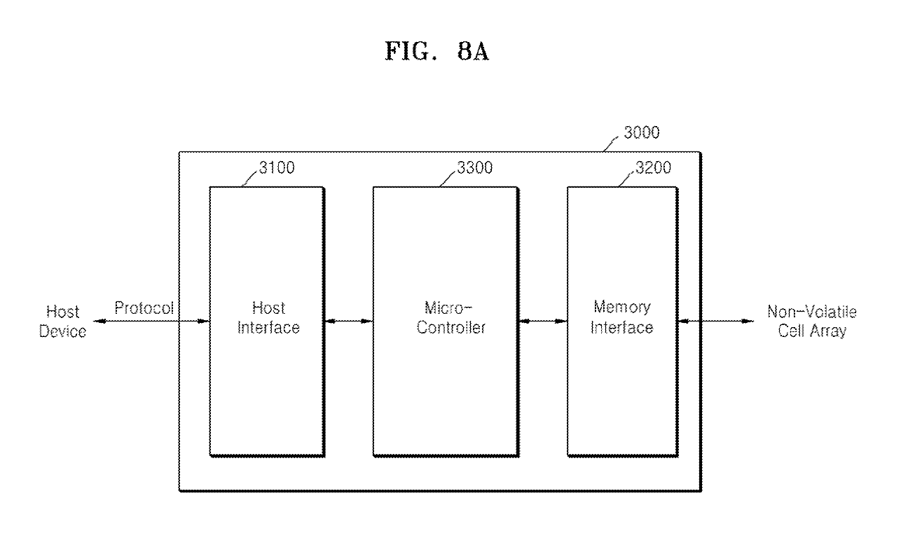

FIG. 7 is a flowchart illustrating an operation of the host device of FIG. 1, according to exemplary embodiments of the inventive concept. The host device may request a non-volatile memory device to transmit mapping information stored in a non-volatile cell array, and may then receive the mapping information from the non-volatile memory device (operation S21). The host device may transmit a request for accessing user data to the non-volatile memory device. For example, the host device may transmit a write or read request for writing or reading the user data. When transmitting the write request, the host device may transmit user data along with the write request. The host device may transmit mapping information regarding the user data along with the request or transmit the mapping information in response to a request of the non-volatile memory device for the mapping information (operation S22). The host device may determine whether the request transmitted to the non-volatile memory device is a write request (operation S23). When the request transmitted by the host device to the non-volatile memory device is not the write request (No, S23), the host device may receive a response from the non-volatile memory device in response to the request (operation S24). When the request transmitted by the host device to the non-volatile memory device is the write request (Yes, S23), the memory controller of the non-volatile memory device may write the user data received from the host device in a vacant storage space of the non-volatile cell array. Accordingly, a physical address of the user data may be changed, and mapping information regarding the user data stored in the host device may no longer be valid. Therefore, the host device may invalidate mapping information regarding the user data transmitted to the non-volatile memory device along with the write request, among the stored mapping information. The host device may store an indication of whether each mapping information is valid or not in an additional storage space (operation S25).

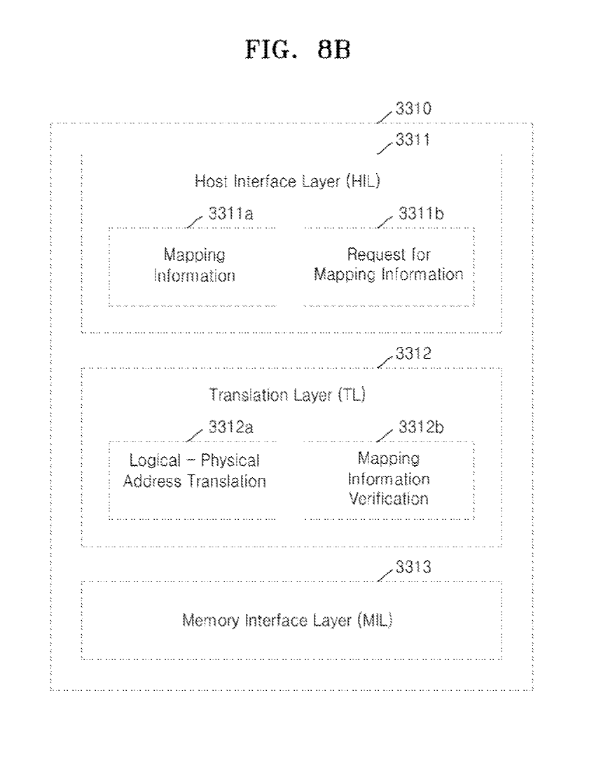

FIGS. 8A and 8B are diagrams illustrating an example of a memory controller of a non-volatile memory device, according to exemplary embodiments of the inventive concept. As shown in FIG. 8A, a memory controller 3000 of the non-volatile memory device may include a host interface 3100, a memory interface 3200, and a micro-controller 3300. The host interface 3100 may communicate with a host device via a predetermined protocol so that the micro-controller 3300 can respond to the host device. The memory interface 3200 may transmit and receive, to and from a non-volatile cell array, signals for the micro-controller 3300 to control the non-volatile cell array. The micro-controller 3300 may execute a predetermined program to control the non-volatile cell array and respond to various requests received from the host device. The program performed by the micro-controller 3300 may be embodied within firmware. The firmware may be stored in a read-only memory (ROM) in which a flash translation layer (FTL) is stored, and may perform various operations in response to requests from the host device.

FIG. 8B is a diagram of firmware performed by the micro-controller of FIG. 8A, according to exemplary embodiments of the inventive concept. Firmware 3310 embodying programs executed by the micro-controller 3300 of FIG. 8A may include a host interface layer 3311, a translation layer 3312, and a memory interface layer 3313. The memory interface layer 3313 may generate control signals for the non-volatile cell array or convert addresses or data transmitted to the non-volatile cell array so that the translation layer 3312 can perform an operation for managing the non-volatile cell array.

The host interface layer 3311 may be a firmware layer configured to perform operations to communicate with the host device. The host interface layer 3311 may transmit or receive mapping information 3311a and a request 3311b for mapping information to or from the host device. For example, when the host device requests the non-volatile memory device to transmit mapping information so that the host device may receive and store the mapping information, the micro-controller 3300 may recognize the request using the host interface layer 3311. Also, when the micro-controller 3300 requests the host device to transmit mapping information stored in the host device, the micro-controller 3300 may transmit the request using the host interface layer 3311.

The translation layer 3312 may be a firmware layer configured to perform an operation of managing the non-volatile cell array. The translation layer 3312 may perform logical-physical address translation 3312a and mapping information verification 3312b. The logical-physical address translation 3312a may include extracting a physical address of the non-volatile cell array based on a logical address or mapping information received from the host device. The mapping information verification 3312b may include determining whether the mapping information received from the host device is valid or not. For example, when the physical address extracted based on the mapping information received from the host device indicates a space to which the host device cannot provide access or when a physical address of user data is changed and the mapping information received from the host device is no longer valid, the mapping information verification 3312b may include ignoring the received mapping information. When the mapping information received from the host device is scrambled or otherwise encrypted, the mapping information verification 3312b may further include an operation of unscrambling the mapping information.

The translation layer 3312 shown in FIG. 8B may further perform bad block management, wear-leveling, or error correction to manage the non-volatile cell array. For example, when the non-volatile cell array of the non-volatile memory device is a flash memory, the translation layer 3312 may be referred to as a flash translation layer (FTL).

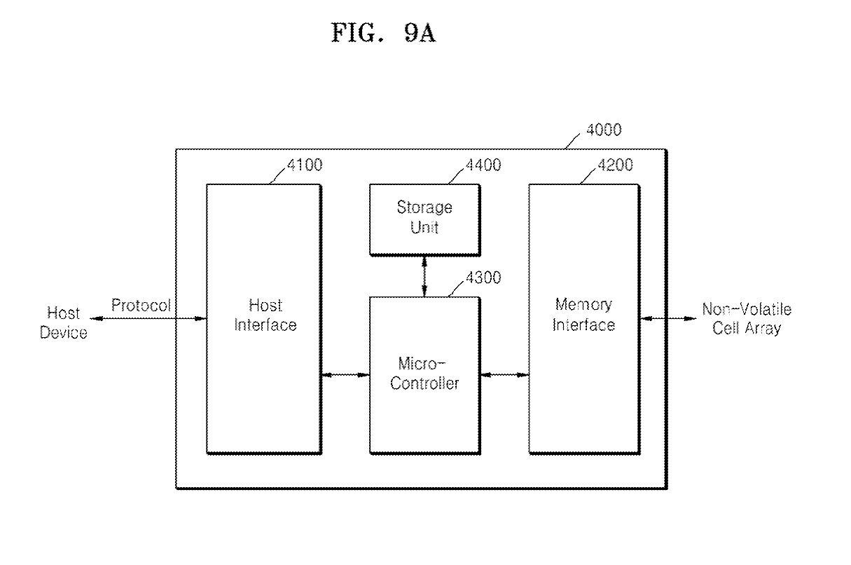

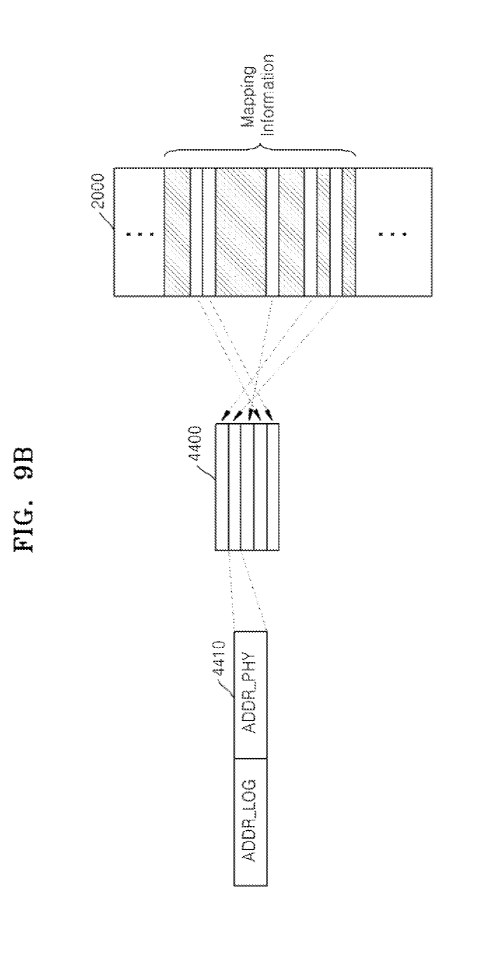

FIGS. 9A and 9B are diagrams illustrating examples of the memory controller of the non-volatile memory device of FIG. 1, according to exemplary embodiments of the inventive concept. As shown in FIG. 9A, a memory controller 4000 may include a host interface 4100, a memory interface 4200, a micro-controller 4300, and a storage unit 4400. As described above with reference to FIG. 8A, the host interface 4100 and the memory interface 4200 may generate signals required for the micro-controller 4300 to communicate with the host device or control the non-volatile cell array. The memory controller 4000 may further include the storage unit 4400. The micro-controller 4300 may directly access the storage unit 4400 and write or read data to or from the storage unit 4400 at a high speed.

FIG. 9B is a diagram illustrating an example of the storage unit of FIG. 9A, according to exemplary embodiments of the inventive concept. The storage unit 4400 may store at least a portion of mapping information stored in the non-volatile cell array 2000. For example, as shown in FIG. 9B, the non-volatile cell array 2000 may not only store user data but may also further store mapping information in a predetermined region. The storage unit 4400 may store at least a portion of mapping information stored in the non-volatile cell array 2000. For example, as shown in FIG. 9B, the storage unit 4400 may store five pieces of the mapping information stored in the non-volatile cell array 2000. Since it takes a relatively long time for the micro-controller 4300 to access the non-volatile cell array 2000 and read the mapping information stored in the non-volatile cell array 2000, the time may affect the speed at which the non-volatile memory device responds to a request for providing access to the user data from the host device. Accordingly, although the micro-controller 4300 has a smaller storage capacity than the non-volatile cell array 2000, a portion of mapping information may be stored in the storage unit 4400 having a relatively high data write/read speed, and the micro-controller 4300 may access the storage unit 4400 so that the number of times the micro-controller 4300 accesses the non-volatile cell array 2000 can be reduced. For example, the storage unit 4400 may serve as a cache memory of the non-volatile cell array 2000 in which mapping information is stored. The storage unit 4400 may be embodied as including one of various kinds of memories, for example, a static random access memory (SRAM) cell array or a dynamic RAM (DRAM) cell array.

The mapping information stored in the storage unit 4400 may be present in each unit of user data. For example, when the non-volatile cell array 2000 is a flash memory, the mapping information may be present in each page. Meanwhile, the mapping information may be present in units of sectors, which are data transmission units of the host device. As shown in FIG. 9B, one piece of mapping information 4410 may include a logical address ADDR_LOG and a physical address ADDR_PHY. Although FIG. 9B shows an example in which the storage unit 4400 stores five pieces of mapping information, it is obvious that the number of pieces of mapping information stored in the storage unit 4400 may be changed, according to various embodiments.

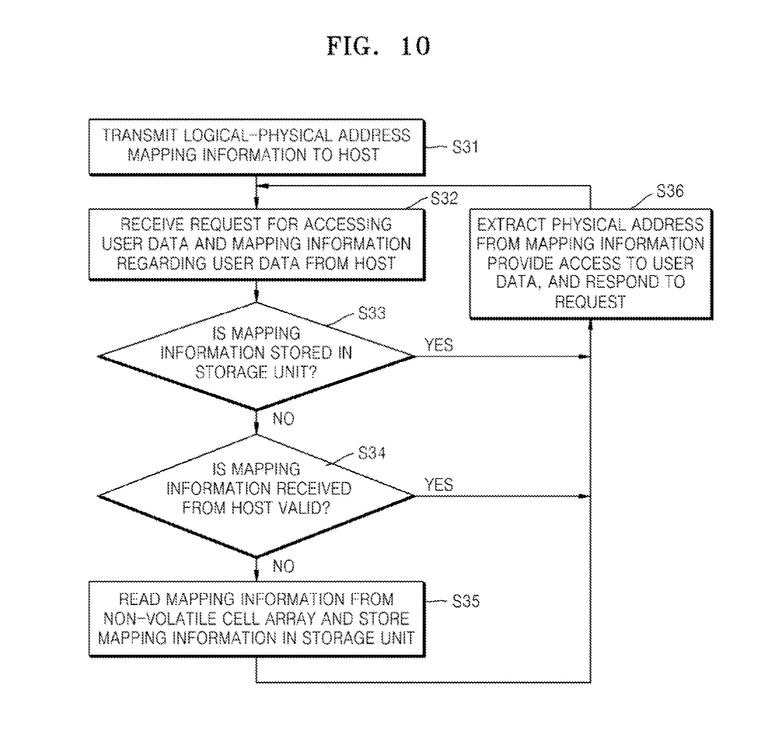

FIG. 10 is a flowchart illustrating an operation of the memory controller of FIG. 9A, according to exemplary embodiments of the inventive concept. The memory controller of the non-volatile memory device may transmit mapping information stored in the non-volatile cell array to the host device in response to a request from the host device (operation S31). The host device may store the mapping information received from the non-volatile memory device. The host device may transmit a request for accessing the user data and mapping information regarding the user data to the non-volatile memory device, and the memory controller may receive the request and the mapping information via the host interface (operation S32). The memory controller may determine whether the mapping information received from the host device is stored in the storage unit (operation S33). When the mapping information received from the host device is stored in the storage unit (Yes, S33), the memory controller may extract a physical address based on the mapping information stored in the storage unit, provide access to user data indicated by the physical address, and respond to the request from the host device (operation S36).

When the mapping information received from the host device is not stored in the storage unit, the memory controller may determine whether the mapping information received from the host device is valid (operation S34). When the mapping information received from the host device is valid (Yes, S34), the memory controller may extract a physical address based on the received mapping information, provide access to user data indicated by the physical address, and respond to the request from the host device (operation S36). In contrast, when the mapping information received from the host device is invalid (No, S34), the memory controller may read mapping information from the non-volatile cell array and store the mapping information in the storage unit (operation S35). When the memory controller stores the mapping information in the storage unit, an operation strategy of a cache memory may be used. For example, a least recently used (LRU) strategy for replacing the least recently used mapping information with new mapping information may be adopted. The memory controller may extract a physical address based on mapping information read from the non-volatile cell array, provide access to user data indicated by the physical address, and respond to the request from the host device (operation S36).

As shown in FIG. 10, due to the operation of the memory controller described herein, the number of times the memory controller accesses the non-volatile cell array can be reduced. As a result, speed at which the non-volatile memory device responds to a request from the host device can increase.

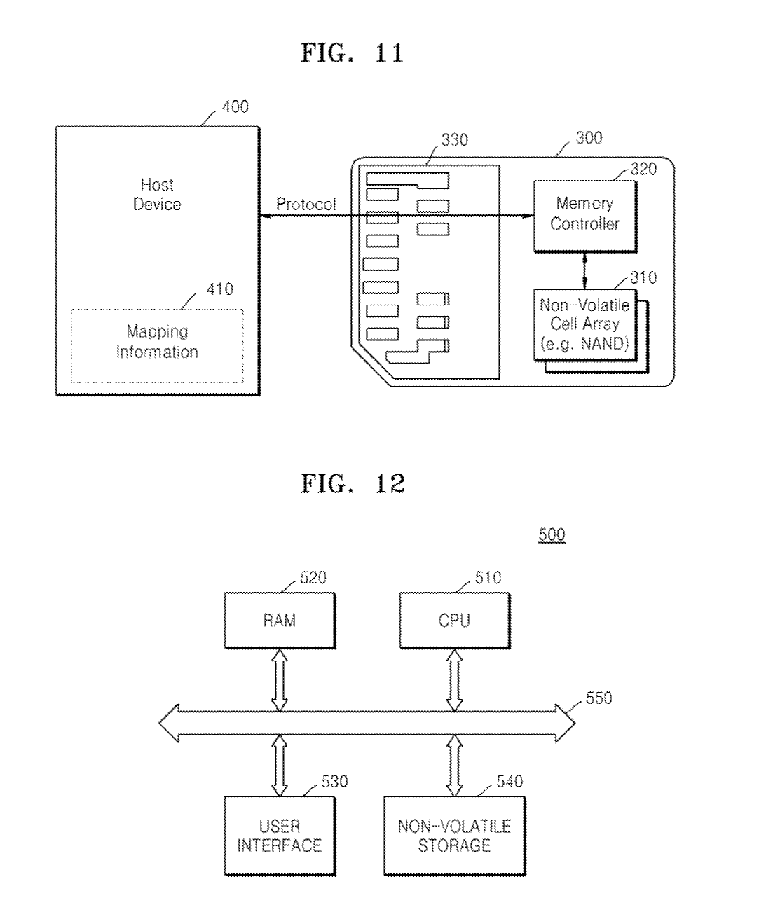

FIG. 11 is a construction diagram of a memory card and a host device, according to exemplary embodiments of the inventive concept. The non-volatile memory device described above may be a memory card 300. For example, the memory card 300 may be an eMMC or an SD card. As shown in FIG. 11, the memory card 300 may include a non-volatile cell array 310, a memory controller 320, and a port region 330.

The non-volatile cell array 310 may include cells capable of retaining stored data even when power supply is interrupted. For example, the non-volatile cell array 310 may include flash memory cells, MRAM cells, RRAM cells, FRAM cells, or PCM cells. The memory controller 320 may perform operations such as those described above. The memory controller 320 may include a storage unit, which may store at least a portion of logical-physical address mapping information regarding user data stored in the non-volatile cell array 310. The storage unit may be embodied by a memory having a higher response speed than the non-volatile cell array 310 and may include, for example, an SRAM cell array or a DRAM cell array. The memory controller 320 may communicate with a host device 400 through the port region 330 according to a predetermined protocol. The protocol may be an eMMC or SD protocol, a SATA, a SAS, or a USB.

The host device 400 may store logical-physical address mapping information 410 regarding user data. As described above, the host device 400 may receive mapping information from the memory card 300, store the mapping information, and simultaneously or discretely transmit a request for accessing user data and mapping information to the memory card 300.

FIG. 12 is a block diagram of a computing system 500 including a non-volatile storage and a host device, according to exemplary embodiments of the inventive concept. When the computing system 500 is a mobile device or a desktop computer, a non-volatile storage 540 may be mounted as a non-volatile memory device, for example, as described above.

The computing system 500 according to exemplary embodiments may include a central processing unit (CPU) 510, a random access memory (RAM) 520, a user interface 530, and the non-volatile storage 540, each of which may be electrically connected to a bus 550. In the computing system 500 of FIG. 12, a host device, such as described above, may include the CPU 510 and the user interface 530. The CPU 510 may control the entire computing system 500 and perform operations corresponding to commands input by a user via the user interface 530. The RAM 520 may function as a data memory of the CPU 510, and the CPU 510 may receive mapping information from the non-volatile storage 540 and store the mapping information in the RAM 520.

The non-volatile storage 540 may include a non-volatile cell array and a memory controller. The non-volatile cell array of the non-volatile storage 540 may include a memory capable of retaining stored data even when the power supply is interrupted. The memory controller of the non-volatile storage 540 may be any one of the memory controllers of the non-volatile memory devices described above.

While the inventive concept has been particularly shown and described with reference to exemplary embodiments thereof, it will be understood that various changes in form and details may be made therein.

What is claimed is:

1. A non-volatile memory device comprising:
a non-volatile cell array configured to store data and mapping information, the mapping information including a logical address of the data and a physical address of the data; and
a controller configured to transmit, to a host device external to the non-volatile memory device, at least one portion of the mapping information stored in the non-volatile cell array, receive, from the external host device, mapping information of data requested to be accessed, and access the data requested to be accessed based on address information extracted from the mapping information received from the external host.

2. The device of claim 1, wherein the controller further comprises a storage unit to which the at least one portion of the mapping information stored in the non-volatile cell array is copied,
wherein the controller accesses the data requested to be accessed based on the mapping information stored in the non-volatile cell array or the mapping information received from the external host device.

3. The device of claim 2, wherein the controller determines whether the mapping information received from the external host device is invalid, and
when it is determined that the mapping information received from the external host device is invalid, the controller accesses the data requested to be accessed based on the mapping information stored in the non-volatile cell array or the mapping information stored in the storage unit.

4. The device of claim 2, wherein the controller requests the external host device to transmit mapping information stored in the external host device, and receives, from the external host device, the mapping information stored in the external host device.

5. The device of claim 2, wherein when mapping information regarding the physical address corresponding to the logical address of the data is changed, the controller stores the changed mapping information in the non-volatile cell array or the storage unit and transmits the changed mapping information to the host device.

6. The device of claim 1, wherein the controller further receives a request from the external host device to access the data, and receives a plurality of logical addresses and a plurality of physical addresses in response to the received request from the external host device to access the data.

7. The device of claim 1, wherein the controller scrambles or otherwise encrypts the at least one portion of the mapping information, transmits the scrambled or otherwise encrypted mapping information to the external host device, unscrambles/decrypts the scrambled or otherwise encrypted mapping information received from the external host device, and accesses the data based on the unscrambled/decrypted mapping information.

8. The device of claim 1, wherein the controller comprises:
a verification unit configured to determine whether the mapping information received from the external host device is invalid;
a data access unit configured to access the data stored in the non-volatile cell array by using the mapping information received from the external host device; and
a mapping information transmitting unit configured to transmit, to the external host device, the at least one portion of the mapping information stored in the non-volatile cell array.

9. The device of claim 1, wherein the non-volatile cell array is divided into one or more sectors, or one or more pages,
wherein the logical address of the data and the physical address of the data are addresses of the sector, the page, or a mapping unit internally managed by the non-volatile memory device.

10. The device of claim 1, wherein the non-volatile cell array is a NAND flash memory.

11. A non-volatile memory host device comprising:
a storage unit configured to store mapping information having a logical address of data stored in a non-volatile memory device and a physical address of the data stored in the non-volatile memory device; and
a controller configured to communicate with the non-volatile memory device and transmit a request for accessing the data stored in the non-volatile memory device and to transmit the mapping information stored in the storage unit, wherein the transmitted mapping information relates to the data requested to be accessed to the non-volatile memory device.

12. The device of claim 11, wherein the controller receives, from the non-volatile memory device, mapping information stored in the non-volatile memory device and stores the received mapping information in the storage unit.

13. The device of claim 11, wherein when the transmitted request is a write request, the controller invalidates the mapping information, stored in the storage unit, of data relating to the write request, and updates the invalidated mapping information with new mapping information.

14. The device of claim 11, wherein the controller receives updated mapping information from the non-volatile memory device and copies the received updated mapping information to the storage unit.

15. The device of claim 11, wherein the storage unit stores scrambled or otherwise encrypted mapping information, and
the controller transmits the stored scrambled or otherwise encrypted mapping information to the non-volatile memory device.

16. A memory controller for a non-volatile memory device comprising:
a host interface for receiving mapping information from a host device;
a verification unit configured to determine whether the received mapping information is invalid;
a data access unit configured to access data stored in the non-volatile memory cell array using the received mapping information; and
a mapping information transmitting unit configured to transmit, to the host device, at least one portion of the mapping information stored in the non-volatile cell array.

17. The memory controller of claim 16, further comprising a storage unit to which the at least one portion of the mapping information stored in the non-volatile memory cell array is copied, wherein the data access unit is configured to accesses the stored data based on the mapping information stored in the non-volatile cell array or mapping information received from the external host device, on the direction of the verification unit.

18. The memory controller of claim 16, wherein the memory controller and the non-volatile memory cell array are integrated into a single non-volatile memory device.

19. The memory controller of claim 18, wherein the single non-volatile memory device additionally includes a port region through which the memory controller communicates with the host device.

20. The memory controller of claim 18, wherein the single non-volatile memory device is a memory card, a solid-state drive (SSD), or a USB memory stick device.
